(19) United States
(12) Patent Application Publication
(10) Pub. No.: US 2025/0165899 A1
(43) Pub. Date: May 22, 2025

(54) DECISION MAKING SKILL DEVELOPMENT SYSTEMS, METHODS, AND COMPUTER READABLE MEDIUM

(71) Applicant: Next Jump, Inc., New York, NY (US)

(72) Inventors: Yong-Chul Charles Kim, New York, NY (US); Meghan Messenger, New York, NY (US)

(21) Appl. No.: 18/956,550

(22) Filed: Nov. 22, 2024

Related U.S. Application Data
(60) Provisional application No. 63/602,261, filed on Nov. 22, 2023.

(51) Int. Cl. G06Q 10/0639

(52) U.S. Cl. CPC G06Q 10/06398; G06Q 50/2057

(57) ABSTRACT

Systems, methods, and computer readable medium are provided that relate to, among other things, establishing data structures that quantify test-determined parameters related to identifying and improving core decision making skills, implementing adapters that interface with enterprise application services (and data) to identify signals relevant to the parameters from the user activity within the enterprise service, implementing in conjunction with these feature a private online workspace, and providing training through the workspace based on the signals determined from the (other) enterprise services. Signals can be automatically determined by interfaces to other enterprise application services such as email, employee feedback, employee evaluation, and other systems.

### CROSS REFERENCE TO RELATED APPLICATIONS

This application claims the benefit of priority to U.S. Provisional Patent Application No. 63/602,261, filed on Nov. 22, 2023. The entire content of which is herein incorporated by reference.

### FIELD OF THE INVENTION

The present invention is generally related to the field of digital interactive human resources technology, including employee development and decision-making training systems.

### BACKGROUND OF THE INVENTION

Employees are perhaps the most valuable asset of an organization. Keeping and attracting employees often requires that the organization invest resources to develop the employees. Employee training and development is typically directed to further education in the field of industry of the employee. This type of training typically provides academic education. There is currently no known solutions for developing employee decision making skills in an objective, consistent, efficient, and critical way. Accordingly, these and other deficiencies are to be addressed and improvements sought over existing digital interactive human resources technology tools and systems.

### SUMMARY

In accordance with principles of the present invention, computer-implemented systems, computer-implemented methods, and computer readable medium are provided for decision-making skill development of employees of a company.

For example, a computer is implemented that is configured using non-transient memory to execute computer readable instructions. The instructions when executed performing steps comprising one or more operations. The steps including implementing one or more enterprise applications on the enterprise network of the company, each enterprise application adapted to provide a different service to the employees that login to use the corresponding service over the enterprise network, and each of the plurality of enterprise applications configured to have different corresponding database schema and data structures that are resident in that application for operating that application and each of the plurality of the enterprise applications is configured to have a corresponding database that implements the corresponding database schema and data structures. The steps also including implementing a decision making skill development service software application as an enterprise application on the enterprise network with the one or more enterprise applications, wherein the decision making skill development service software application is configured to determine a quantitative value for the decision making skill of individual employees and determine one more signals or signal levels that are components of the decision making skill of individual employees, the determinations being made from data adapted from the one or more other enterprise applications, wherein the corresponding database schema and data structures of the decision making skill development service is different from the database schema and data structures of the one or more other enterprise applications.

Another steps includes implementing one or more adapters, each adapter configured to operate with a corresponding specific one of the one or more other enterprise applications and configured to collect resident data about individual employees from the corresponding specific one of the one or more other enterprise applications, wherein each adapter comprises a set of kernels and each set is adapted for a corresponding one of the one or more other enterprise applications and wherein each kernel comprises an algorithm that detects one of the defined signals and/or its signal level from the collected resident data of the corresponding specific one of the other enterprise applications, the kernel applying the algorithm to produce a particular signal and/or signal level as a function of the collected resident data, and wherein one or more signals or signal levels are stored by the decision making skill development service software application in accordance with the database schema and data structures defined for the decision making skill development service software application.

The steps can include identifying the quantitative value for the decision making skill for an individual employee by combining the produced signals and/or signal levels which were produced from data about the particular employee from other enterprise applications, storing the quantitative value for later retrieval, displaying an interactive display screen that displays the quantitative value to the particular employee, implementing a training application that comprises a set of online training courses, implementing an algorithm that uses the signal and/or signal levels for the quantitative value of the decision making skill to identify a corresponding subset of the one or more of the training courses; and providing an interface configured to allow the particular employee to selectively access and use the corresponding subset of the one or more of the training courses.

In some embodiments, the computer is further configured using the computer readable instructions to implement a private workspace for the particular employee, wherein the private workspace is for exclusive use of the particular employee to view the quantitative value and access the corresponding subset of the one or more of the training courses.

In some embodiments, the decision making skill development service software application is configured to process collected resident data to anonymize contributor information.

In some embodiments, a table is implemented that identifies the corresponding subset of the one or more training courses using the one or more signal levels of the particular employee.

In some embodiments, the system stores the quantitative value as a reference and is configured to collect data and run one or more kernels again in response to determining a flag has been triggered.

In some embodiments, the decision making skill development service software application is configured to display a bar graph containing the quantitative value and reference markers for levels of achievement.

In some embodiments, one of the other enterprise application is an employee evaluation applications and the adapters for the employee evaluation application is configured adapt resident data of the employee evaluation application to determine one or more signals and/or signal levels of the particular employee.

In some embodiments, one of the other enterprise application is an anonymous employee feedback application and the adapters for the anonymous employee feedback application adapts resident data of the anonymous employee application to determine one or more signals and/or signal levels of the particular employee.

In some embodiments, the algorithm of one or more kernels comprises performing a geometric calculation on the collected resident data to determine one or more signals or signal levels.

In some embodiments, the enterprise applications are implemented as cloud service that makes the services available to the employees through the Internet.

It is understood that various embodiments are contemplated.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates one embodiment of the system for decision-making skill development in accordance with some embodiments of the invention;

FIG. 2 illustrates a part of an example user interface that provides an interactive visual graphic (a bar) in accordance with some embodiments of the present invention;

FIG. 3 is a functional block diagram and process illustrating an example embodiment for a system for a decision making skill development software tool in accordance with embodiments of the present invention;

FIG. 4 is a functional block diagram and process illustrating an example embodiment for collecting, adapting, standardizing, and/or updating data from other enterprise applications and related controlled updates in accordance with one or more embodiments of the present invention;

FIG. 5 is a diagram illustrating a kernel adapted for an enterprise evaluation application in accordance with one or more embodiments of the present invention;

FIG. 6 is a diagram illustrating another kernel adapted for an enterprise email system in accordance with one or more embodiments of the present invention;

FIG. 7 is a diagram of a graphical user interface illustrating an example display screen for a signal in accordance with one or more embodiments of the present invention; and

FIG. 8 is a diagram of a graphical user interface illustrating an example display screen for interacting with the training application as part of one or more embodiments of the present invention;

### DETAILED DESCRIPTION OF THE INVENTION

In accordance with the principles of the inventions, advances in human resources (“HR”) technology provided by way of interactive computer implemented tools, software processes, and systems that improve on existing employee decision-making assessment and development technology. There are many advantages and valuable aspects of the present technology and a few such aspects are initially discussed.

Based on research conducted, there is a need for digital interactive tools directed to training employees of an enterprise to develop “soft” skills, which are non-academic, and in particular, directed to developing the decision-making skill of company employees. Decision making is a critical aspect of employee performance that is historically underdeveloped and difficult to measure. There are also difficulties in identifying and implementing successful and accessible solutions that benefit the employees of an enterprise in a systematic, efficient, and objective way. Systems developed in accordance with embodiments of the present invention provide an accessible and efficient interactive digital tool and related features that provide a material improvement in this field.

Decision-making skill means the measure of how prepared an individual is to tackle ambiguous and highly uncertain work. In today's world, companies require individuals and teams that have a high level of decision-making skill (high performing individuals or teams) for the company to be successful. This is a challenging problem for companies. Decision making is a quality that cannot be directedly detected such as in detecting physiology, e.g., taking blood pressure. In addition, without an objective measure for the current state of the skill, training directed to the skill cannot be properly identified and can be misdirected (e.g., could cause a decline). Often times, the skill can be confused or blurred with another characteristic or experience of the individual. Known conventional technology provides no systematic and scientifically based approach to detecting the skill, is not able to tailor the training, and does not track or detect the delta in the skill. The known approach also fails to provide a self-directed system that the individual can use and work in with privacy and confidence. Accordingly, known human resources employee decision-making skills technology lacks accuracy, objectiveness, reliability, and other desired characteristics.

The applicant has implemented a testbed, a platform for conducting rigorous, transparent, and replicable testing of scientific theories, computing tools, and new technologies, in the applicant's enterprise using the applicant's employees, technology infrastructure, and other applicant (company) resources. The testbed is implemented as a tool for training and to experiment and develop new tools for achieving a high performing work force.

The applicant has included as being available or used on the testbed, an anonymous peer feedback system, an employee evaluation system, an emotional journaling application, and other employee-interactive enterprise tools such as an email server, and/or other systems. The applicant's computer systems are configured to implement, operate, and store data used and generated by these enterprise applications (e.g., the enterprise feedback application). The applicant has conducted research using the testbed in various ways to study, through experiments and testing, the decision-making skill similar to scientific experiments when scientists study a compound or composition. An objective being that through inductive or logical deduction, they understand and interpret the decision-making skill and define primary components, as identifiable elements, that bind or interact to compose the decision-making skill. The experiential and logical testing and experiments used various enterprise systems implemented for employee and company use such as peer feedback, evaluation, and other resources and observation of the actions of the employees. The closed computer and human environment is implemented with purpose for achieving various conditions adapted to provide reliable data. For example, the closed computing environment protects against external (e.g., public) participants acting or using the system to the detriment of others. Participants are identified and registered such as on the company employee database even if they may be participating anonymously sometimes. The computer systems are behind layers of security network and database security protections that can clearly wall off (through security measures) the collected personal information from unauthorized access. This is a trusted environment (and if desired a trusted anonymous environment) both from a computer and an employee aspect of it.

The applicant using the testbed has researched the decision-making skill and through this work identified certain signals, essential components, that are found to make up the composition of the decision making skill. Through this process, the components were detected to be a) self-awareness, b) bias to take action, c) coachability, d) reactive balance, and e) vision balance. Each is briefly explained below.

Self-awareness refers to the metric that measures how aligned the individual is with the individual's peers (the team that the individual is a member of), individual's coach(es) (other employees that are in a coaching role with respect to the individual), or a combination thereof. The Applicant's research has shown that this metric is a signal or carries a signal of a primary constituent component of the decision-making skill. Meaning high performance in this metric objectively shows strength in the limited set of signals of high performing decision-making skill. For example, data that when analyzed by way of an automated algorithm detects a major gap (based on determined values or geometric pattern comparison) between the individual's evaluation of themselves versus the evaluation of the individual by that individual's peers demonstrates a low value for the self-awareness metric. Thus, it carries a weak signal of self-awareness as a component of the data value for the decision-making skill.

The system is further discussed below, as an example, and can include determination with respect to four characteristics or signals over a determined or defined past period for the individual (employee). The four other signals are described below.

Bias to take action refers to the metric that measures rapid execution by the individual. The metric is identified to show, when high performing, the skill to take smart, fast, and bold action. The rapid execution has been found to be an asset in an enterprise. The Applicant's research has shown that this metric is a signal or carries a signal of a constituent component of the decision-making skill. Meaning high performance in this metric shows strength objectively in the limited signals of high performing decision-making skill.

Coachability refers to the metric that measures discipline and authenticity to one's coach or mentor.

Reactive balance refers to the metric that measures the individual is balanced in the process of observing, orienting, deciding, and acting in handling a task or a problem. This has two components, thinking skill and execution skill. Research from the testbed has shown that having skills in both parts is important. There are two common imbalances that have been identified in the testbed. First, people who are “under reactive” tend to over think and over plan before acting (tendency towards passivity). Second, people are “over reactive” who tend to take action before properly understanding a situation (tendency towards reckless decision-making). Both of these are reactive decision making, which has been determined, through research, to carry a weak sign of this metric.

Vision balance refers to the metric that measure an imbalance due to two common biases. The research has shown that some people tend to over focus on the past and overlook the importance of predicting future outcomes and having a vision, while others tend to over focus on the future and disregard the lessons learned from past experiences. Either imbalance transmits or carries a weak signal for this metric as a components of the decision-making skill.

The Applicant developed a system that incorporates and adapts data sources of the company to detect the four signals and the level or value for each signal. The system is further configured to apply an algorithm using the signal levels that determines the decision-making skill of the individual, and in doing so determines a numerical value for the decision-making skill for that individual. This is a quantitative value determined from the scientific approach used in the definition and development of the system.

The decision-making skill system is configured to implement a private electronic workspace (e.g., a space available through a browser) that is privately accessible for use in the process for that individual. The system can display in the workspace graphical representations and/or graphical user interfaces that communicate the data and analysis for the user. This is configured using servers, for example, to be only accessible to that individual unless the user provides access to another individual or technical support is needed if desired. The decision-making skill system is configured to include a database of electronic training material such a videos, interactive tutorials, or other content that is prepared and structured to train the individuals to perform at a higher level with respect to the decision-making skill. The training can be saved on a server and the system can be configured to select which one of the plurality of the training material (e.g., individual video session) is selected for that individual, e.g., for consumption in their workspace.

The decision-making skill system is configured to categorize the individual training material to match individual signals. For example, a low score in the detected value of the self-awareness signal is determined to correspond to a certain set of training materials that is directed to elevating that signal. A training material can be tagged to correspond to more than one signal or can be tagged when there is a specific combination of two to five signals having a predetermined threshold or high/low band of values.

The Applicant has developed, through research, analysis, and testing, individual conversions or translations of collected or processed data in different corresponding enterprise applications that communicate or carry the key signals (and level of signals). For example, in connection with the anonymous peer feedback system, the applicant developed individual kernels (distinct conversions or translations of structured data in another enterprise system where the structure data was found to carry a key signal in one way) due to having certain data adapted for that system that converts the data resident in that application to identify one of the key signals and determine a level for that signal. The kernel (which is a digital element) is configured to specify the data variables in the anonymous peer feedback system and the translation or conversion (algorithm) to be adapted to work in (e.g., have the data structure used in) the decision-making skill system. A plurality of distinct kernels are programmed that are each operating to perform a different conversion or translation. The kernel may comprise an algorithm that operates on the data (retrieved data from a needed data variable in the anonymous peer feedback system). The anonymous peer feedback system is one example. For example, two different sets of data variables in the anonymous peer feedback system can be used to identify and carry the same signal or they could each be for a different signal. This data mining can involve many different kernels that each discover signal information from, the likely, vast data collected by the enterprise system about employees. Kernels can be developed and added as the system is further developed in the future. The kernel may be able to detect signals that are particularly available from a corresponding system. For example, a first type of signal may be best detected from a first system (e.g., the anonymous peer feedback system) while another type of the five signals is best detected from a second system (e.g., the emotional journaling system). The kernels are adapted to detect the signal from the data pool (data lake) of structured data that exists in the different enterprise systems. Preferably, the enterprise system does not determine or measure the signals (the individual signals) because, for example, they are systems that are directed to other applications. This is a data mining operation that is performed to surface relevant information from other data. Using the algorithms the system finds unknown properties or characteristics.

A library of kernels can be stored in different sets that each correspond to “mining” a different enterprise system for signals. Each set of kernels is particularly developed and adapted for a corresponding one of the enterprise system. This includes being configured to match the data structure of that resident aspect of the enterprise system. Matching the data structures includes knowing the data structure of the database that supports the operation of that enterprise system so that the desired data can be retrieved from the database. The decision making skill system is configured to incorporate the sets of kernels and to trigger the kernel operation. By using the kernels, the decision making skill system operates adapters (potentially multiple adapters for each enterprise system) that produces data as a function of the data stored in the enterprise systems to operate and support the operation of the decision-making skill system. An adapter (software) can be configured for each of the other enterprise applications and each adapter can comprise or be defined by its own set of kernels. The decision-making skill system is configured, preferably, to control when the kernels are executed and tracks (by storing information) the history of each kernel (e.g., when that data was mined). The decision-making skill system is configured to use the tracked information to identify when to run individual kernels again (e.g., to receive update results). Preferably the kernels are configured to include a time variable that determines or controls the range or amount of data that is used by the kernel in that instance that it is running. This programmed aspect preferably allows for producing results for one or more time windows such as to allow for a comparison of the individual's performance in the selected time frame and then later for a time window after training is presented to the user.

The decision-making skill system is preferably configured to be notified of or query the status of the enterprise systems (one or more of them). When data is updated in the enterprise system (e.g., meeting a threshold), after a preset time, or due to a triggering event, the data from the one or more enterprise systems is digested using the kernel(s) (corresponding set of kernels). This operation updates the decision making skill measurement to be updated with the new data and to be current such as to be up to date (e.g., in real time or near real time correspondence to the current performance level of the user). As soon as the data is available, a notification or trigger system as part of the decision making skill system or overall enterprise system engages in collecting the signals and determining the quantitative value for the decision making skill. The system collects, converts, and consolidates employee data from the different enterprise applications. The converted data is in a standard format (of the decision making skill system) that is used by the decision making skill system, which allows for the integration and use (and update) of the across the different sources within the decision making skill system. The consolidation, for example, involves combining or merging the signals from the different enterprise applications.

Through research, certain (limited) attributes have been found to have a close relationship with evaluating and improving decision making skills. As such, in some aspects, the systems and software described herein develop a new form of technology that implements a decision making training system.

Embodiments of the present invention provide a quantitative assessment of the decision making skill. The quantitative assessment may be used by the individual for developing a training program (e.g., selection of specific training modules)—with or without a coach—for improvement and/or development of his or her skills (e.g., decision making skills). Specifically, the tools of embodiments of the current invention quantify, based on the inputs, current behavioral characteristics (as interpreted by the system using the data).

Embodiments of the present invention relate to a structured system using a combination of software, hardware, data structures, security, and restrictions to provide an advanced interactive electronic decision-making skill development system. For example, an application can be implemented that provides employees of a company with an interactive user interface that is adapted to provide the user with the ability to self-evaluate themselves with respect to their decision making skill. The application is preferably configured to establish a private online space (e.g., accessible via a mobile application or website user interface) that the individual user can configure to limit access to his/her private space. The space is where the user can view his or her numerical rating and related signals, and which can be configured to allow others—specifically one or more invited coaches—to have access to the information in that private space. The application can receive data from many different enterprise applications and if desired, strip or remove the identification (personal identifying information) of the employee. The privacy and control over access to data can be implemented by way of tables that specify the information that an individual user that logs in has permission to receive.

As a matter of background, typically company assessment systems provide a direct rating for a particular specific question and the meaning of the combination of evaluation information is left for the subjective understanding of the employee and the human resources department. The conventional tools do not implement, among other things, advanced features that allows for self-analysis and detection of indirect information as a function of the inter-relationship of the different attributes, that is consistent across multiple companies and/or within a company. For example, by way of a software engine comprising adapters, a system is implemented that stores a library of algorithms that each have a corresponding signal and related stored data. The software engine is configured to apply the library of algorithms (e.g., to produce quantitative values for individual signals). The algorithms can include many levels of complexity, such as being able to detect interrelationships between certain attributes in an employee evaluation system (as a data source). For example, does the average of a first and third attribute in a particular enterprise application result in a higher number than the score of the second attribute. If so, the algorithm would convert that information to a signal level for an associated signal. Or, for example, does the average of a first and third attribute, in that particular enterprise application, result in a higher number than the score of the second attribute while the score for the second attribute is lower than each of both the fifth and fourth attributes. If so, the result can be that the information carries one of the signals and it has a low numerical value. A complex analysis of many different patterns can be performed and classified from the automated data analysis based on a corresponding library of information. The detection through the algorithms and the stored resulting information can be used to display the detected signals (and corresponding decision making skill score) or other automated assessments to the user through a structured report that is displayed to the user in the application. The process is applied so that the same adapters and results are consistently used for the employees in the company. This provides a digitally defined level (and consistent) playing field for the employees.

The process is structured to have a set of specific (different) signals that the software engine detects and reports for example a predetermined set of separate sections in a report which is configured to provide a structured view of the report. The system provides an objective system in a manner that is consistent for all employees.

There can be a provider of the application that can maintain the library of signals, decision making skill score, and retrieved data locally or remotely. The provider can periodically update the tool to refine the accuracy and content based on additional employee interactions. With this information, an employee is enabled to self-guide personal development of skills to improve attributes in a level way relative to others at the company. The application is further configured to be available to the user to maintain a history of the user's signal scores and decision making skill score so that the user can also benefit from viewing historical information via a graph and reports. A web interface can be provided for the various features such as in combination with a mobile application. Various embodiments are contemplated such that for example individual features may by themselves have critical implementation value or may have it in various combination of features herein.

The decision-making skill application is configured to send login and password information to a personal identity service, wherein the personal identity service receives and authenticates the user, provides or sends an electronic security token to the decision-making skill application that the decision-making skill application sends to the related service (e.g., decision making skill software service application) to obtain authorization to operate in the service. The authentication and the system is configured to use the authorization token to enable access to other services offered on the enterprise network of that company or by that enterprise employing that user to gain access to the other services (e.g., to all other services or join the enterprise network and have access to enterprise application). This process provides efficiency in that the user and system do not require separate logins for each of the enterprise's applications to access corresponding services. In addition, it can protect anonymity because it can disassociate the user's login or name from the interactive process in the service. The interactive process in the service can use a numerical or alphanumerical identifier (or other non-descriptive identifier) for communications (in the packets or messages) to the service that would not be understood visually or otherwise easily used to identify the user of the mobile device. In addition, the security process and the use of tokens establish highly secure inter-system relationships and connections (e.g., trusted connections using communications and security protocols) based on identity authentication and security tokens used in messaging. The evaluation service, for example, may be the evaluation processing software application.

The decision-making skill system can be configured to provide an interface on the user's personal mobile phone by having an application running on the mobile phone. This can provide security, speed of use, and other benefits such as a reduction on employee's hardware resources.

The system (e.g., available on employee's mobile phone, which is almost always with a user) provides the signal and decision making skill score along with an interface that provides for navigating training. The system is also configured to maintain confidential the identity of other employees, to the extent involved, who were involved or contributed, as noted in the databases, to the data used in determining the skills and score for that user.

The application on the user device is preferably configured to be a lightweight application (e.g., through a browser) that places minimal processing or storage requirements on the device. The application generates the interactive display screen, providing interactive tools. The information that is displayed in the application is retrieved after the user opens the application (from a closed state) and is running on the device. The application will request the information in response to the user selecting an interactive option (e.g., selects to view current score or select training). An HTTP GET command can be used for this process. For example, when the user selects the option to view a decision making skill score and related report, the application in response transmits a command requesting the messages. The service (e.g., decision making skill software service application) responds by sending a set of the messages.

The application (e.g., decision making skill development application) uses the local volatile memory (e.g., a cache or memory buffer) of the device to store the information, on the device in supporting the operation of the application including the ability to present display screens that include the received information. Preferably, when the user closes the application on the device, the received information is no longer accessible because it was part of volatile memory and it frees up the storage on the device for other applications.

The application (e.g., decision-making skill development application) is configured to communicate with a service (e.g., decision-making skill service software application) implemented on a server using interactive data messaging such as by using HTTP GET and HTTP POST messages. Preferably email protocol messages or chat messaging is avoided and is external to and/or independent from the application. The application prepares messages to interact with the service by creating the data portions of the message and associating related tags, and further using JSON on the device to prepare communications messages (or packets) on the device, which are transmitted by the device over wired and/or wireless networks such as Wi-Fi or mobile telephone networks.

Another application that can be configured to work over or in conjunction with this system is an evaluation processing application. The data collected by the system from the evaluation process can be saved and used in conducting analytics by the decision-making skill service software application

Implementations and embodiments of such systems, interactive tools, applications, or interfaces (etc.) in accordance with principles of the inventions are further described below. The discussion includes additional relevant details depending on the embodiment and advantages and technical benefits are also described or understood from the explanation. The term decision-making skill system is sometimes in recognition that the described system is directed to electronic interactive systems involving determining user decision-making skill and involving decision-making skill development.

The decision-making skill system sends requests to obtain data, retrieves data, or applies adapters to data in other enterprise applications to obtain converted and formatted data (for the decision-making skill system) from other feeds. The decision-making skill service software system includes a first database containing user's information and a data cache and retrieval system that is devoid of user's information or has user's information encrypted (in general, it should be understood that various combination are contemplated). The first database is protected with security measures or security configuration so that no one (except authorized users) can access it to determine the user identity. The decision-making skill system may also include adapters that is used to analyze data resident in other enterprise applications or systems of the company such as an anonymous feedback system or employee evaluation system.

Technical improvements over the prior art can for example include:
Software applications and systems that can protect with higher confidence the confidentiality of user decision making skill information;
A adapters that utilizes algorithms to identify decision making skill signals from indirect information carrying such signals in other applications or databases on the enterprise containing employee user information;
Private self-development space based on automated analytics;
Use of automated analytics, consistently in the enterprise and beyond due to the system implementation for development or improvement of the decision making skill;
A virtual container system for providing bundled software, libraries, and configuration files for executing the systems and methods of embodiments of the invention in a manner that is isolated from other virtual machine instances/applications/data for preserving security and integrity of information contained therein;
Scientifically dissect the decision making skill into a set of five different signals (e.g., only the five signals);
Determine a quantitative value for decision making skill from the signals;
A system that collects and adapts data from the many enterprise applications to generate resident data adapted for the decision making skill system and further includes controls that updates through interaction with the enterprise applications to update the resident data (e.g., to track changes for an employee); and
Structured reports and visual graphics.

Other improvements of the invention will become apparent from consideration of the drawings and ensuing description. The contemplated systems and methods provide a truly effective and objective mechanism that can be used s motivate improvements in decision making skills, teamwork and quality.

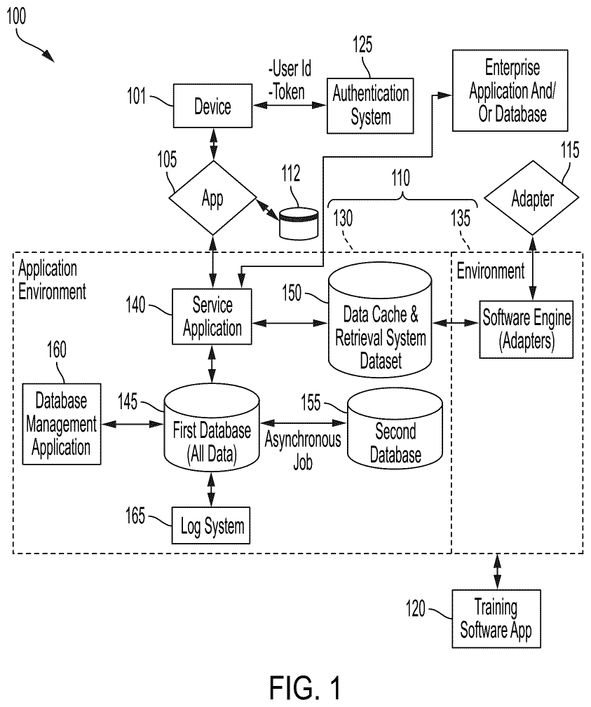

FIG. 1 illustrates one embodiment of the system 100 for the decision-making skills application. The system includes a decision-making skill development application 105 is made available via browser or application installment (or combination thereof) on a first electronic device 101. In implementation, there would many electronic devices in the system for use by the employees. The system further includes a decision-making skill service software application 110 implemented on one or more servers (processing system), an adapter software application 115 implemented on one or more servers (enterprise system adapters), and a training software application 120 implemented on one or more servers (training system). The electronic device can be personal computers, servers, mainframes, virtual machines, containers, gaming systems, televisions, and mobile electronic devices such as tablet computers, laptop computers, and the like. Each of the electronic devices and servers is a computer system that includes a microprocessor and volatile and non-volatile memory to configure the computer system. The computer system also includes a network connection interface that allows the computer system to communicate with another computer system over a network. The decision-making service software application 110, the adapter software application 115, and the training software application 120 may be implemented on the same severs or different servers. The system may include one or more of the aforementioned software applications, instead of all three. Each software application may also be used independently or in conjunction with another software application (a software application other than the above three software applications) to strengthen or supplement functionalities of the other software application.

The decision making skill software application 105 includes a login interface and performs a user authentication process to allow the user to access the evaluation software application. It should be noted that the user may be provided a first type of access that allows them to solicit other users to be given access to the user's information on the application. In other words, the first type of access allows the user to access his/her private space. On the other hand, the system may be configured to provide other users that are selected by the user to provide them with a second level of access that only allows them access to the user's private space. For example, the system may allow the user to request through the system to add a mentor to have access to the private space. The different levels of access may be configured automatically (e.g., using a rule set) based on the role of the user using the decision-making skill service software application 110. The system can be configured using the permissions to block the individual user's employer, supervisor, human resources department or others from being able to access the individual user's decision-making skill data (e.g., their private space) unless access is authorized by that user such as by being a mentor selected by that user.

The decision-making skill application 110 is also configured to send reminders or notifications, whether in the application or through email. The notifications may be provided by the evaluation software application such as through push notification, a pop-up window, sound, or vibration, or by the system or EMS sending an email with the reminder.

A user can enter his or her sign-in credentials from the login interface through the electronic device and the entered information is transmitted over a network to another computer system by the electronic device. The computer system receiving the user's credentials may be an authentication system 125 that may be part of the system 100. For example, the sign-in credentials of an employee may be his company sign-in credentials that include information that identifies that the user is an employee of the company, such as an email address based on the company's email domain, employee identification number, or other employee identifiers. Upon receiving the credentials, the authentication system checks if they (e.g., an email address and password) match the credentials stored in the authentication system (e.g., the email address and password pre-stored in the authentication system). The credentials stored in the authentication system, for example, may be created and stored in the authentication system when the person joins the company and the human resources department of the company creates an email address and password for that person through the company's computer system. The credentials stored in the authentication system can be updated when the user changes his credentials (e.g., password). The authentication system is configured to store sign-in credentials of the employees hired by the company. This authentication implementation is configured to use the authorization token to enable access to services offered on the enterprise network of that company or by the enterprise employing that user to gain access to the services (e.g., to all other services or to join the enterprise network and have access to enterprise applications such as the decision-making skill software application and employee database). This process provides efficiency in that the user, or the system implementing each enterprise application, does not require separate logins for each of the enterprise's software applications on the user's electronic device to access corresponding services. At the same time, this process also establishes highly secure inter-system relationships and connections, such as trusted connections using communications and security protocol, based on identity authentication and security tokens to ensure that unauthorized individuals or individuals outside the enterprise do not have access to the enterprise applications. This security implementation provides a simplified authentication process or one single authentication process that can simultaneously verify that the user is an employee of the company and allow the user to access all enterprise applications on the enterprise network. In some applications, employees use their own personal mobile phone on the premises of the employer or remotely, which would implement the mobile application and would then connect to the enterprise software platform through the authentication process. For example, the device could be an external device that is receiving the benefit of enterprise resources through logging via cellular data, another company's Wi-Fi, or company's Wi-Fi.

Optionally, the sign-in credentials may be different from company sign-in credentials. In such examples, for first time users, the user's credentials may be generated by the authentication system 125. In some embodiments, first time users can also create their own credentials from the login interface.

Upon receiving the credentials, the authentication system 125 checks if they match the credentials stored in the authentication system (stored as a result of the authentication system generating the credentials for first time users creating the credentials). If they match, the authentication system 125 generates an authorization or security token and sends it over the network to the electronic device 100. The decision making skill application 105 incorporates the token into all of its data to or communications with the decision making skill service software application 110. The token is required to communicate with those software applications and is checked and verified by those software applications before the decision making skill software application 105 can access the functionalities and data in the decision-making skill service software 110 and/or employee database 112. The authentication system 125 may generate a user identifier in response to the match and can transmit it over the network to the decision-making skill software application 105. The user identifier may also be included in some or all of the decision making skill software application 105's data or communications with other software applications and/or electronic devices. The token is required to communicate with those systems and database and is checked and verified by those systems and database before the decision making skill software application can access the functionalities and data provided by those systems and database. The user identifier may be a code or number that only the system or software applications knows as the identity of the user. For example, the user, another user, or a technician does not know the identity of the user when the code or number is presented to that individual. If the credentials do not match, the user (or electronic device) is prevented from accessing the decision making skill software application 105 and other software application and an invalid message is transmitted to the user.

Similarly, the authentication system 125 may control access to the decision making skill software application 105 by other unregistered users (e.g., non-employee users), via a second electronic device. For example, the decision making skill software application may provide the token to the second electronic device for allowing access to unregistered users.

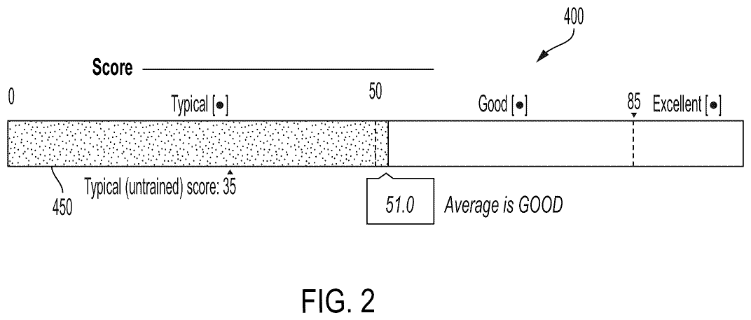

Once access to the decision making skill software application 105 is granted to a user, the decision making skill software application 105 provides user interface(s) (e.g., on the first electronic device 101) that allow the user to perform several functions such as, view decision making skill results, work on development of skills or training, or the like. For example, FIG. 2 illustrates a part of a graphical user interface 400 that allows a user, in response to selecting an option to view the quantitative determination, display the current quantitative for that user of the decision-making skill. As shown in FIG. 2, the user interface may be configured to be shown as a bar 450 that illustrates the quantitative number relative to determined ranges for the numbers, as shown, typical, good, excellent. The display also includes information about the typical score without training. A command may be a button (physical or digital button), an icon, a tab, a window, or the like permitting users to activate a functionality of a software application or a computer system.

For clarification, in FIG. 1, for example, the application is a web server implemented as part of the application environment and running the service application. The application can be configured to be implemented as a software as a cloud type application on a browser on a mobile phone or other type of device. The application provided by the web server is provided over a communication network, which can include the Internet. Other web or types of implementations are contemplated. As mentioned, a mobile application implementation can include installing a mobile application configured for the decision-making skill system on the mobile device so that user can interact through the software app on the mobile device.

A user may invite or authorize a coach or mentor to view at least part of his or her private space in order for the user to work with the coach or mentor in reviewing his/her decision readiness skill information (e.g., the quantitative score). This can be implemented by having the coach being provided access to the data by way of the application displaying the information to the coach in his or her interactive space generated by the application. The user can only view his/her decision-readiness skill information (e.g., the quantitative score) from the decision making skill application on his/her electronic device, into which he needs to login (see login and authentication processes described above) if he/she is not already logged in or has been logged out in order to use the application.

With respect to the decision-making skill service software application 110, the servers on which the decision-making skill service software application 110 are implemented and configured to receive the data (from other system or through adapters) via the network connection interface of the servers. The decision-making skill service software application 110 also checks if an authorization token exists and verifies whether the token is valid, for determining the identity of the user, associating the received data with the user. The decision-making skill service software application 110 includes two environments, an application environment 130 and a software engine environment 135. The received data and the token enter from the application environment 130.

In some implementations, the system can be implemented with one database, such as, the first database 145 that is secured for private personal access using the database to segregate the decision-making skill information such as the personal score. A software process can be used as a software module and/or authorization information in a table can be stored to limit the information that is provided in the decision-making skill software application 110.

In one embodiment, the application environment 130 includes a service (or service application) 140 that processes the received data, a first (primary) database 145 for storing the received data, a data cache and retrieval system 150 for storing a portion of the received data, and a second database 155 for storing a portion of the received data. Upon receiving the data, the service 140 stores the received data in the first database 145. The service 140 may store the entire received data in the first database 145. In other words, the service 140 stores what is received (which should be understood to include retrieved) by the application environment 130 in the first database 145. In some embodiments, the service 140 stores at least the decision readiness score (the quantitative score for the decision-making skill) and an associated user identifier in the first database (without the user's name). Other combinations are also contemplated. The data stored in the first database can be raw data, meaning that the data received is the same as the data stored or that there is no additional procedure applied to remove, add, or modify (e.g., encrypt) any data in the received data other than those basic or inherent in the operations of the software application and the servers, such as decoding, etc.

The service 140 also duplicates the received data, removes or erases identifier from the duplicated data that identify other employees (data for determining a score for a user is processed to remove identifying data of other users), and stores the remaining data in the duplicated data (or the duplicated data without the identifier) in the data cache and retrieval system 150. The service 140 may duplicate the received data as the data is received or from the data in the first database 145. The data 150 in the data cache and retrieval system 150 is devoid of user identifiers that associate data for a user with the identity of other users. The data 150 in the data cache and retrieval system 150 can be retrieved using the user identifier by a user (e.g., the user's score and related information), and only upon authentication of the user.

For clarification, the processes performed by the service 140 refers to one or more of the aforementioned storing steps (with respect to the first database 145), duplication step, removal step, and storing step (with respect to the data cache and retrieval system 150). They may further include the step of duplicating and storing the identifiers in the second database 155.

The software engine environment 135, comprising a software engine, (sometimes referred to as software engine 135) accesses the data in the data cache and retrieval system 150 to perform data conversation or translations to detect signals in external enterprise applications and to adapt to the data structure of the decision making skill service software application.

Each environment and service may be referred to as a system or subsystem within the software based application for providing the decision-making skill development tool to users.

In, the identifier removal embodiment or asymmetric encryption, the data in the first database 145 and the data cache and retrieval system 150 may be stored as tables. The received data can be transformed into different data structures such as tables by the service 140 before it is saved, or by the database 145 or the data cache and retrieval system 150 after the service 140 provides the data. For example, the service 140 (or the first database 145/the data cache and retrieval system 150) can create tables by separating the data by data variable identifier (or variables in a defined data structure such the score, identifier, time, etc.) as a table. a first set of received data from a record from another application (or database) can be classified in one category and saved in one table, and a second set of received data from the record which may include an identifier may be classified in a separate category and saved in another table. The two-table format is saved in the first database and the data cache and retrieval system. As discussed above, any identifiers of those who contributed to that users score or component signal can be removed or encrypted before being saved to the data cache and retrieval system. As such, the two tables in the first database includes the identifier of those involved in the determination for that user (contributor identifier) and the two tables in the data cache and retrieval system either is devoid of that identifier or has the identifier encrypted. The environment 135 may access the data in the two-table format. The contributor identifier in the second database 155 may be duplicated from the data in the two-table format in the first database 145.

The data cache and retrieval system 150 is used by the service 140 to retrieve the necessary data in response to a request sent by the decision-making skill service software application 110 such as using service 140 (e.g., performing an update to the score after the user received training using training software app 120)). The data cache and retrieval system 150 is used by the service 140 to keep contributor's identity anonymous since the contributor identifier is either unavailable or encrypted. As mentioned, a contributor is an employee (or in some cases it could be expanded) that was contributed to the data used to identify signals and generate a signal for a user such as those involved in the employee evaluation process or if emails are used as a source, those involved in the emails (sending to or receiving from emails from the user that is the subject of the determination). Contributor identifier in the second database 155 is used or encrypted evaluator identifier is unencrypted only in limited circumstances by the environment 135 when analytics requires it. Furthermore, the data cache and retrieval system 150 is used by the service 140 such that a user can only access his/her scores and signals, without access to the contributor identifier.

The data cache and retrieval system 150 (or the retrieval system for simplicity) is a system that includes a cache mechanism, an index mechanism, and a database. The cache mechanism may be based on Redis or memcached technology and is used to cache the data in the retrieval system 150, in particular the data that has been previously found, retrieved, processed, or determined. For example, when the service 140 queries a database in response to a request sent by the evaluation software application 105 and the retrieval system 150 returns the results, the results are stored in the cache for a period of time so the results can be quickly accessed when they are called (e.g., can be retrieved in several milliseconds, instead of several seconds). The index mechanism search indexes the data in the retrieval system 150 and saves the indices in the index mechanism. The index mechanism enables quick searching for the data in the retrieval system 150. The data searched by the index mechanism may be either data that has not been searched before, or data that has been stored beyond the period of time allowed by the cache and is cleared from the cache. The index mechanism may be the default mechanism used by the retrieval system 150 to search data and the cache mechanism may be used by the retrieval system 150 if the data to be searched is already in the cache mechanism. As to the database, the cache mechanism and the index mechanism operate on the data in that database to retrieve the necessary data. For example, the index mechanism may inverse-index each score and signal (including level) in that database. When a search is conducted, such as by the environment 135 or the service 140 for data stored in the retrieval system 150, the index format allows the environment 135 or service 140 to quickly identify and retrieve those messages. Other techniques and platforms related to searching are contemplated.

The retrieval system 150 also includes two security measures or configurations to protect the identity of a contributor as well as the information of a user (the subject of the decision making skill service software application. One security measure is that the contributor identifier is used by the retrieval system 150 to find data (from other applications) including any information stored in the retrieval system 150 that the contributor has given or is a source or contributor of for the adapter. The user (and the evaluation software application and the retrieval system) cannot use it for other purposes, such as to look up evaluations or information about other people. Similarly, the user identifier is used by the retrieval system 150 to find data such as scores or signal values stored in the retrieval system 150 corresponding to that user. That identifier only allows that particular user (through his or her software application and the retrieval system) to look up the scores or signals (without contributor identifiers—i.e., anonymously) he has received. The user (and the software application and the retrieval system) cannot use it for other purposes, such as to look up evaluations other people have given for other users or identities of the contributors. Another security measure is that the retrieval system 150 provides public key-private key cryptography or is configured to work with a system implemented with such cryptography. When a system is without asymmetric cryptography, the retrieval system 150 can provide such functionality and the system can operate as described above. When a system already has this feature, the encrypted contributor identifier is indexed by the retrieval system and used to anonymously and quickly find contributing information (that is also indexed) the individual of that identifier has given.

The data cache and retrieval system 150 may be referred to as an enterprise search and index engine that is capable of retrieving information from many different databases, including the database in the system 150 and other databases. This can include interfacing via communications with other enterprise applications to request and obtain and can include, depending on the architecture directly requesting the data from the database of another enterprise application. The system 150 provides quicker and more responsive capabilities in the context of the decision-making skill development system. For example, the user interface of the system can simplify the decision making skill information to be saved and the system 150 can quickly index, save, search, and retrieve data because of the simplified structure. In systems that do not provide a simple user interface, the amount of information received, e.g., from a Word or PDF document, may be significant such that using system 150 may not be as quick and efficient in indexing, saving, searching, and/or retrieving data.

The first database 145 storing the raw data or all the received data (including the contributor identifier) is built with security measures or configurations to prevent unauthorized access. The first database 145 may be implemented in another private network and sit behind a firewall that is different from the private network and firewall in which the decision making skill service software application (excluding the first database 145) is implemented. For example, accessing the first database 145 may require a different login process or credentials from those of the decision making skill application (a separate portal). The first database 145 may be known as a production database server. The security measures or configuration can be implemented in two levels, application level and database level.

In one embodiment, the first database 145 is highly restricted such that only a certain software and service application can access the first database 145 (application level). The first database 145 is also highly restricted such that only a certain individual who has complete access to the first database 145 or who has at least the access to the contributor identifiers in the first database 145 can access the first database 145 (database level). On the application level, the first database 145 may grant permission to the decision-making skill development application 105 and the service application 140 (and only those applications) allowing them to write into and read from the first database 145. The decision-making skill development application 105 and the service application 140 may be configured such that they write data into the first database 145 and read data from the data cache and retrieval system 150. On the database level, only the first database creator and individuals approved by the first database creator have access. The creator and authorized applications and people can view or retrieve the raw data, including the contributor identifier and the actual data such as an evaluation or feedback message, from the first database 145. The raw data is not encrypted. The creator and allowed individuals access the first database 145 through a two-step security process. First, they are required to log into the private network on which the first database is situated that is different from the private network on which the evaluation processing software application (excluding the first database) is situated. Second, their credentials are checked by the first database 145 whether they have permission to access the data in the first database 145 if they want to access that data. In some embodiments, the second step may involve submitting another login credential that is different from the first step. Both are privileged access and require permission from the creator. Only individuals who pass both steps can access or view the raw data in the first database 145. Some individuals may be granted with only the first privilege access so that those individuals can modify or update the hardware and software of the first database 145 or work on the first database 145 for other purposes such as testing and network related issues. Those individuals, however, do not have access to the raw data in the first database 145.

A database management software application 160 is implemented to interact with the first database 145. The database management software application 160 may be accessible only by the first database creator. The database management software application 160 provides a user interface allowing the first database creator to grant first database access permission to software applications (e.g., applications 105, 140) and individuals (e.g., users who are granted with the first privilege access and users who are granted with the second privilege access). Users who are granted with the second privilege access means users who are granted with the first and second privilege access.

A user access log system 165 (or software application) is also implemented to interact with the first database 145. The log system 165 may be part of the first database 145 or the decision-making skill service software application 110. The log system 165 is configured to record every authorized user's access to the first database 145, including the first database creator's activities. The log system 165 can record activities that happen under the first privilege access and the second privilege access. For example, activities that occurred under the first privilege access may include the identity of the authorized user, the hardware, software, data, and network the authorized user modified, the date and time of authorized user's actions, and other information. Activities that occurred under the second privilege access may include the identity of the authorized user, the raw data the authorized user accessed, such as contributor identifiers and actual evaluations, corresponding evaluatee identifiers, the date and time of user's actions, and other information. The log system 165 is configured by the first database creator or other professionals (e.g., technicians, engineers, network administrators, IT specialists, etc.) to be accessible by a limited number of users so that they can check if anyone (including the creator) has accessed the data in the first database 145. Since the system is configured to keep contributor's identify anonymous, the log system 165 is designed to check if there is any human access to the data in the first database 145 that may compromise a contributor's identity, compromise evaluation information, etc. when individuals are not supposed to access this information.

Another embodiment of the security measures or configuration for the first database 145 can also be implemented. The second embodiment is also implemented in the application level and the database level. On the application level, it involves two entities, software application and service application, and application administrators. Software application and service application (or one of the applications) are provided with a security key or hash that enables them to encrypt a data such as an evaluation and to access the first database 145 (e.g., storing the encrypted data such as an evaluation in the first database and retrieving the encrypted data such as an evaluation from the first database) only for authorized users (e.g., the corresponding user). The same security key may also allow software application and service application to decrypt retrieved data (e.g., evaluation), or software application and service application may be provided with a second key to decrypt the data (such that the actual message and rating and the contributor identifier can be seen or be otherwise available). Application administrators, e.g., professionals who manage or control the evaluation software application and service application, may also have the decryption key and may be the only individuals who have such a key. The first database 145 and database administrators (described below) do not have the decryption key and are unable to decipher the encryption.

On the database level, it also involves two entities, the first database and database administrators. The first database 145 is equipped with a security mechanism that can check whether a user trying to access the first database 145 has the necessary security key (the first database 145 itself may also have such a key). Database administrators, e.g., professionals who manage or control the first database 145, may be the only individuals who are provided with such a key. The security key for the first database is different from the encryption/decryption key in the application level. The software application and service application and application administrators (described above) do not have the security key for the first database 145 and are unable to access the first database 145.

Based on the above, accessing and decrypting the data in the first database 145 such that the actual data such as actual message, rating and contributor identifier can be seen or be otherwise available requires both the decryption key and the first database's security key. Both keys may be generated and provided to their respective administrators at the onset when the second embodiment of security measures or configuration is installed. A platform may be implemented with the second embodiment that allows the administrators to submit their keys. The administrators can access the data in the first database 145 and decrypt the data in the first database 145 from the platform. To further strengthen the security level of the second embodiment, application administrators and database administrators may be limited to individuals who hold the most senior positions (in terms of ranking) or executive-level positions in the organization, or those who can make executive decisions on behalf of the organization (e.g., Chief Executive Officer, Chief Financial Officer, and Chief Technology Officer). For example, the application administrator may be the CTO and be provided with the decryption key, whereas as the database administrator may be the CEO and be provided with the security key to the first database. Therefore, it requires both the CTO and CEO to submit their respective keys into the platform in order to access and decrypt the data in the first database (in order to see the actual evaluations and identities of the evaluation givers). As such, the first database creator may not have either key and is unable to access or decrypt the data in the first database 145 even though he designs and installs the first database and its technology (e.g., its security measures or configuration).

The second embodiment may be referred to as a foolproof security model with distributed security access (e.g., between application administrators and database administrators). Security measures or configuration based on the combination of the above two embodiments are also contemplated. Security measures or configuration based on the combination of one or more features in the first embodiment and one or more features in the second embodiment is also contemplated.

The decision-making skill development application 105 and the adapter software application 115 may not be able to access the first database 145. Both applications may be directed to the data cache and retrieval system 150 to obtain the necessary data.

Implementing the service, databases, data cache and retrieval system, and security measures discussed above allow the system to maintain contributor's identity anonymous while still being able to perform analytics on retrieved data from other applications that is given by or associated with a contributor in a limited, unexposed manner (without compromising contributor's identity). Embodiments of the disclosure ensure the highest level of access restriction and data protection, in particular to information identifying the contributor, as well as only allowing a user to access his or her decision making skill score, signal data, or related data or analysis. The first database and related applications and systems built with the above features improve the operations or security operation of the first database. They may also improve the storing and organization of the received information in the decision-making skill service software application 110 in some embodiments.

However, such levels of security may not be implemented in some embodiments. For example, control over which data is accessible or shown to users can be controlled using the above-mentioned tables that specify the authority of the user and this can be without application level or database level security. It can also be without performing the more complex anonymization processes described, for example.

It should be noted that while the above description describes keeping the contributors identity as anonymous, the disclosure is not so limiting, and in some embodiments, the system may not use such anonymization features.

The software engine includes computer algorithms and artificial intelligence that are programmed to perform the operations. The software engine is also configured to identify user's corresponding signals using the received data (e.g., in their resident data structures) from the other applications. The software engine uses the data in the system 150 to make such determinations and analysis. The software engine environment uses the data in the system 150 so that the identities of the contributors are kept anonymous. In some embodiments, however, the software engine environment can further consider the data in the second database 155, if necessary.

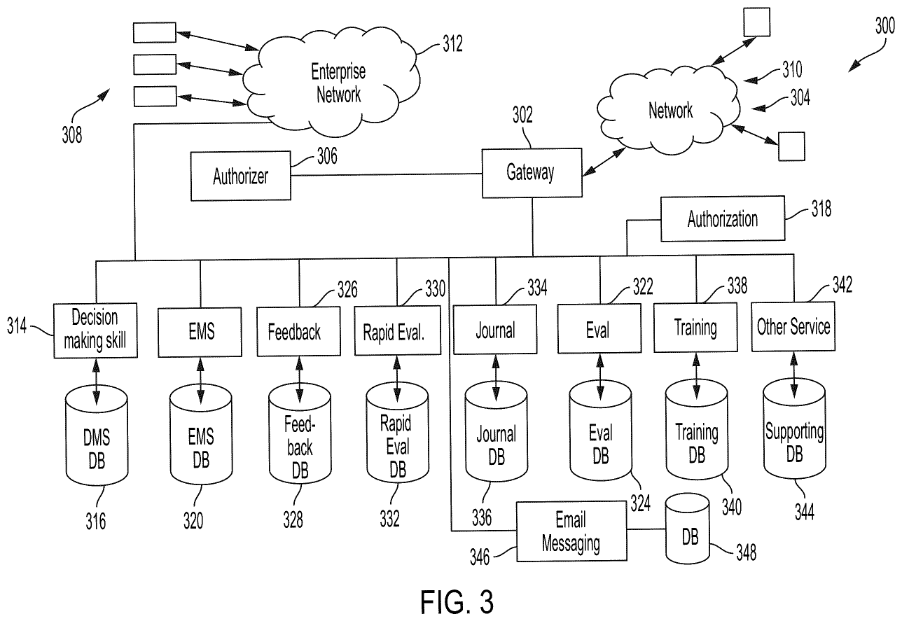

FIG. 3 shows a functional block diagram for an enterprise system (for a company to supports its operations and HR resources) in accordance with one or more embodiments of the present invention, which implements the features, processes, or applications illustratively described herein. The gateway 302 can be implemented using a cloud service, and devices such as mobile telephone 304 can run a mobile application configured to communicate with the gateway 302 when operating the mobile application (e.g., a mobile application designed and adapted, dedicated, to be the decision-making skill development application such as application 105 of FIG. 1). The gateway 302 comprises a computer server that is configured to operate as the communication interface for communicating with the mobile phones 302. The addressing of messages by the mobile application for the decision making skill development tool is directed to the gateway 302. The gateway 302 is connected to an authorizer server 306 that is implemented to evaluate security tokens transmitted by the mobile phones 304 as part of or in conjunction with the operation of mobile application (transmitted message) to determine whether the mobile phone, its user, is an authorized user and checks the security token and authorizes the gateway to transmit the transmitted message from a mobile phone to the backend system.

The company may have implemented an enterprise network 312 that is secured behind a firewall and/or other security from external access such as from public attack or access from the Internet. It is typical for companies to implement their own enterprise network to support their IT system and to implement ranges of private services or tools exclusively to employees on the enterprise network. This includes situations in which the service is made available through a local enterprise network (e.g., ethernet) that connects through the Internet (using security protections) to reach and interact with a cloud service provider that hosts the service for the company. Different locations of a company's network can be interconnected using a wide area network or other network connection to allow for geographically diverse locations while still being on the company's enterprise network. Device 310 can be a personal computer or mobile device of employees that join the company's enterprise network 312 by for example being on premises. These devices will also involve an authentication and authorization process to allow the device to join the network and interact with the services. Device 310 can be a personal computer or other device that is configured to operate in a similar way as described with respect to mobile telephone 304 but the app may be running as a software as a service (within the cache of a browser) to provide user access. Devices 308 can be similarly configured to use a locally installed application or operate through a browser to provide the described functionality. A range of different services are provided on an enterprise network and the different services can login, authenticate, and authorize devices to receive access and use the services using the illustratively described processes.

The backend system includes the decision making skill development service comprising a server application 314 that implements the decision making skill development tool in conjunction with operation with the devices 304, 308, 310. The service can have a unique URL identifier within the backend system (or enterprise internal data network or domain) that is used in communications by the devices to identify that resource for providing the service (which can provide added security).

The decision making skill development service includes one or more supporting databases 316 (e.g., see database in FIG. 1) that is configured to be a resource within the service that is accessible by the decision making skill development service. The backend system may configure the decision making skill (DMS) database 316 to be only accessible by the decision making skill development evaluation service. For example, the DMS database 316 comprising a computer and a database (e.g., MYSQL database) does not have a network address on the same network as the decision making skill development service or server, or other services. The DMS database 316 can also be configured to be only authorized to respond to requests from the decision making skill development service. This example is a service-oriented architecture implementation. This is a preferred implementation of the architecture on the back-end which can provide added security.

The decision making skill development service receives and stores data in the DMS database 316. The decision making skill development service receives messages in packets in application level communications with the devices or other enterprise services and collects and saves the data elements in a defined structured database schema for the decision making skill development service in the MDS database. The database schema is configured and has relationally linked data elements, defined in data structures, that are used by the decision making skill development service to quickly assemble different data, based on a particular situation. For example, a received message from device 304 can be converted to a particular query to the DMS database 316 for an individual employee's decision making skill report including signals and the data can be retrieved from the database and converted into one or messages that are transmitted to the requesting application or service.

The decision making server application is dedicated to implementing and making decision making skill development system available to the employee's of the company using their phone or computer device. This system can include a training service that is configured to operate with the decision making skill detection and related tools.

The backend system includes other services such as employee management service (EMS) that contains employee data. The decision making skill development service places a request to the EMS service in connection with responding to requests from the devices. The request seeks to obtain employee personnel data that is needed for responding to the application. This can include information such as a user's identification number, name, or other information that is stored the EMS database 320. At least for security reason, the EMS database is accessible through the EMS service and, similar to the DMS database and other databases that can be on the back end, it is secured by having it accessible through the EMS service, not directly. As mentioned, in some embodiments, direct access can be configured.

The authorization service 318 is a service that can authenticate users and provide a security token based on the authentication. The authentication services 318, if desired, can be located external to the backend system (e.g., it would communicate with the gateway 302 over a data network). The DMS database 316 (and other databases such as the EMS database) are configured to be within the backend system (behind the gateway) and are secured by the architecture of the gateway and services. The authorization service 318 may require information from EMS to authenticate a user (and can interact with the EMS service by way of messages to obtain the necessary information).

In operation, packets comprising messages are transmitted by the user devices such as mobile phones and the decision making skill development service or server (to each other) through the gateway 302. The gateway 302 checks the messages from the devices using the authorizer 306 to make sure that the sender is an authorized user (e.g., using a security token sent in the message). A flow of communications and operational processes is described or is understood from the description herein. Some devices 308 can perform the same operation via the enterprise network 312 and communication with authorization service 318 to be authenticated and authorized to use the services of the enterprise.

The gateway 302 and the backend system can be implemented using a cloud application service provider. For example, a cloud provider such as Amazon® can be used and the decision making skill development service and related applications or services can be implemented on Amazon's cloud (e.g., in simple terms, a data center housing servers by the cloud provider that runs applications for cloud provider's customers, e.g., a company that wants to have the decision making skill development tool for their company running in the cloud, and the installation and running of the software is provided as a service to those customers).

Other services are hosted or resident on the company's network that provide resident tools and services to employees. The services include other digital services including an employee feedback service, a rapid evaluation service, an emotion journaling service, an employee evaluation services, a training service, and potentially other services. As discussed, the decision making skill development service is configured to adapt the resulting work of the other services to generate adapted data in accordance with the database schema of the decision making skill development service and stored in the DMS database 316.

The employee evaluation service is a type of automated system that implements an employee evaluation process as part of the human resources technology of the company. Employee evaluation is, in general, understood to be the company process in which each employee is evaluated by the employing company in view of the employee's performance over an extended period such as three months, six months, or year (e.g., annual evaluation). The process involves requesting evaluations from the employee's supervisor(s) and in some cases from the employee's peer(s), employee's mentor or coach, and/or the employee themself. The service using the employee database is configured to limit the participants to be designated internal company employees. In some embodiments, known external individuals such as the employee's family can be authorized to access the evaluation service to provide evaluations. In general, a contributor to the evaluation is displayed an interactive graphical user interface that provides the user with a list of various interactive options to evaluate the individual such as questions and corresponding ranking for that question. It can also provide a space for a narrative providing an explanation of positive or negative evaluations. The evaluation server application is dedicated to implementing and making an employee evaluation system available to the employee's of the company using their phone or computer device.

The backend system includes the evaluation service comprising a server application 322 that implements the employee evaluation tool in conjunction with the operation with the devices 304, 308, 310. The evaluation service can have a unique URL identifier within the backend system (or enterprise internal data network or domain) that is used in communications by the devices to identify that resource for providing the service (which can provide added security).

The evaluation service includes an evaluation database 324 that is configured to be a resource within the service that is accessible by the evaluation service. The backend system may configure the evaluation database 324 to be only accessible by the employee evaluation service. For example, the evaluation database 324 comprising a computer and a database (e.g., MYSQL database) does not have a network address on the same network as the employee evaluation service or server, or other services. The evaluation database 324 can also be configured to be only authorized to respond to requests from the employee evaluation service. This is a service-oriented architecture implementation. This is a preferred implementation of the architecture on the back-end which can provide added security. Direct communications with another service and the database 324 can be configured if desired.

The employee evaluation service receives and stores evaluation data received from the devices in the evaluations database. The employee evaluation service receives messages in packets in application level communications with the devices and collects and saves the data elements in a defined database schema for the employee evaluation service in the evaluations database. The schema is configured and has relationally linked data elements that are used by the employee evaluation service to quickly assemble different data, messages or responses based on a particular situation. For example, a received message can be converted to a particular query to the evaluation database 324 for an individual employee's performance evaluation and the data can be retrieved from the database and converted into one or messages that are transmitted to the requesting application or service.

The feedback service comprising feedback server application 326 and feedback database 328 is configured in the same structural and functional way as described with respect to the decision making skill development application and employee evaluation service. The feedback server application is dedicated to implementing and making an employee feedback system available to the employee's of the company using their phone or computer device. The employee feedback system is at least different from the evaluation or other services because it is configured to provide a user interface and related processing to allow peers or other employees to electronically provide feedback on an event or activity in which a particular user (the subject of the feedback) was involved. The employee feedback service can be configured as an anonymous peer feedback system that as in the other services limits the feedback communications to those given by company employees. An illustrative employee feedback service is described in Ser. No. 16/795,509, filed on Feb. 19, 2020 which is incorporated by reference herein in its entirety.

The rapid evaluation service comprising rapid evaluation server application 330 and repaid evaluation database 332 is configured in the same structural and functional way as described with respect to the decision making skill development application and employee evaluation service. The rapid evaluation server application is dedicated to implementing and making a rapid employee evaluation system available to the employee's of the company using their phone or computer device. The rapid evaluation system is at least different from the evaluation or other services because it is configured to provide user interface and related processing to allow an employee to receive a rapid evaluation based on a set of interactive questions assessing certain skills or characteristics of the employee and/or employees peers, supervisor, mentor/coach, or others. This evaluation can be given with reference to past performance or activity but as current evaluation of the limits of self-assessment and relation to assessment of others with respect to certain key skills. The interactive system can be used without needs to use the evaluation system since the rapid system can provide “on the spot” evaluation of the employee's skill without needing a history of past performance to work with or include. The rapid evaluation service can be configured as an environment (e.g., a private workspace) that limits the communications to those given by company employees. In some options, external users can be identified and provided authentication to also participate in the rapid evaluation. An illustrative rapid evaluation service is described in Ser. No. 18/160,176, filed Jan. 26, 2023, which is incorporated by reference herein in its entirety.

The emotion journaling service or enterprise emotion journaling service comprising emotion journaling server application 334 and journal database 336 is configured in the same structural and functional way as described with respect to the decision making skill development application and employee evaluation service. The emotion journaling server application is dedicated to implementing and making an enterprise employee journaling or journal system available to the employee's of the company using their phone or computer device. The employee emotion journaling system is at least different from the evaluation or other services because it is configured to provide a user interface and related processing to allow individual employees to write and maintain a private journal digitally that is selectively shared with other employees by that user and can store aggregate data, across a group or companywide, that is anonymized where the resulting information communicates the employees morale at the company (an objective determination of current company morale) through the interaction and features of the journal service. The emotion journal service can be configured to limit the communications to those in the company employees (e.g., using the employee database). The journal server application can be dedicated to provide the journal service. An illustrative enterprise emotion journal service is described in Ser. No. 16/862,114, filed Apr. 29, 2020, which is incorporated by reference herein in its entirety.

The backend system can include the company's email (and/or other messaging) service. The email service can be conventional email service that is typically implemented by company's to provide email messaging (internal or external) service to employees. The system can include an email server 346 that manages the receipt and transmission and of email messages. The email service is dedicated to implement email messaging for the company (and is not part of other systems such as feedback, evaluation, rapid evaluation, journal application, which each have its own communication message structures. The system implements established email communication standards including for message structure. Database 348 is configured to support the operation of the server 346 and contains copies of emails by employees using the system. The emails may be stored for an extended period of time such as emails in the last year, two years, or longer. Other forms of messaging such as instant messaging can be implemented in the a similar way as the email service.

A skill training service comprising training server application 338 and training database 340 is configured in the same structural and functional way as described with respect to the decision making skill development application and employee evaluation service. In some embodiments the skill training service is integrated with and is included in the decision making skill development service. The training server application 338 is dedicated to implementing and making a training system available to the employee's of the company using their phone or computer device wherein the application is at the minimum configured to support the users of the decision making skill development service in engaging in activity that is determined to increase their score. The application can display to the users of the decision making skill development service an interactive set of training items that matches the user's determined decision making skill score (and/or signal scores). The application tailors the training to that user and monitors and saves the status and state of completion of the matched training items (e.g., videos, presentations, or other material). The training service can include its own content playing software or can rely on other resources of the enterprise. The training service can be configured to be private in that the data with respect to the training performed or selected for the user is configured using the application and database to only be available to that user.

One or more other enterprise services may be implemented by the company including corresponding server application(s) 342 and supporting database(s) 344. The other service(s) are configured to operate in a similar way as described with respect to the decision making skill development service and the employee evaluation service.

The databases store data that is processed or stored in a resident database schema and corresponding data structures of that corresponding service. They are configured for its own operation and requirements to be efficient. Each database includes data resulting from a process dedicated to providing a different application than the decision making skill service software application and the data can be collected by the decision making skill service software application and analyzed using detection algorithms such as the kernels, to find information within those other resulting data that surfaces signals and corresponding a decision making skill score. One, some, or all of the enterprise databases can be leveraged or mined by the decision making skill service software application, using kernels, as mentioned, to find signals.

The backend system comprises hardware and software that together provide the features and functionality described herein. At a basic level, one or more servers are implemented in the backend (including the gateway) that are configured to operate as described using computer executable instructions that are stored on non-volatile or non-transitory memory and in operation the server uses the instructions and can rely on volatile or transitory memory to carry its operations.

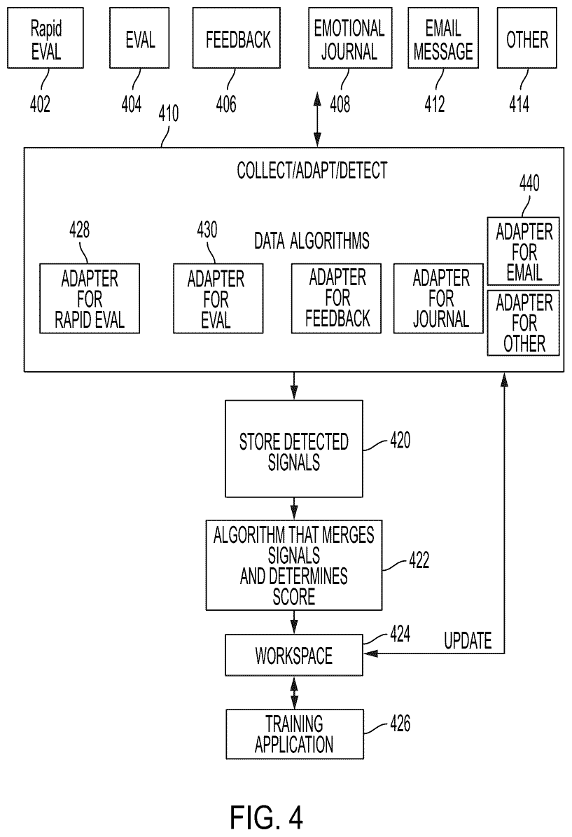

Now with reference to FIG. 4, an illustrative process is described directed to providing a digital service to enterprise users that provides decision making skill score determination and development in an objective way. At step 410, the decision making skill service software application collects data from other enterprise applications. The other enterprise applications can include rapid evaluation 402, evaluation 404, feedback 406, journaling 408, Email/message 412, or other 414 (other enterprise application that collects information about or on individual employees behavior or actions). For example, the decision making skill service software application can communicate, such as to send a request, to one of the other applications to retrieve or collect data from that other application's database. The communication can involve a query to collect data in the data structure and schema defined by the source application for the data. The communication from the decision making skill service software application can involve requests for specific data by specifying the data field defined in accordance with the data structure(s) and/or data schema of the source application and database. The collected data can be stored by the decision making skill service software application. The collected data can be retrieved and stored in a data structure and/or schema of the database of the decision making skill service software application. As discussed, the decision making skill software application includes individual adapters for each of the other applications. Each adapter is implemented and adapted (tuned) to a corresponding one of the other applications. For example, there is an adapter for the rapid evaluation application and another adapter for the feedback application. Each adapter comprises a set of kernels adapted for operating with the data, from a corresponding one of the applications, stored in the decision making skill service software application in accordance with the data structure(s) and/or schema of the decision-making skill service software application.

The decision making skill service software application is configured to apply the set of kernels (or one or more of the kernels) to the collected data. The kernel(s) apply one or more detection and evaluation algorithms that identify signals for a corresponding employee and corresponding value for the individual signals. In operation, the collected data is converted to signals (if any are detected) and stored for later retrieval by the decision making skill service software application. The source enterprise application is dedicated to a different purpose but the different application can carry signals in ways unique to that application. For example, one of the enterprise applications (e.g., the evaluation application) has been found to be a reliable platform for detecting and determining the awareness gap signal for individuals while another one of the enterprise applications (e.g., email application) has been found to be a reliable platform for determining and detection of the reactive balance signal for individuals. The decision making skill service software application can be configured, if multiple other enterprise applications provide data, to selectively determine which application should be used for each signals. The application can also apply the algorithms to the extent they cover any of the signals and combine (e.g., aggregate) the data. As discussed, the decision making skill service software application can include a number of features that are implemented to protect the identity of contributors and users using the application and to protect against access to the data such as to maintain a private workspace for individual users so that they can view their scores and related signals and use the supporting training system privately.

At step 420, the decision making skill service software application stores the determined signals for an individual user in the application's database for retrieval. At step 422, the decision making skill service software application operates on the signals for an individual (or group of employees) by applying stored algorithms to convert the signals to produce a decision making score for an individual (or group of employees). The same algorithms will be used across the enterprise and the system is configured to be implemented in the same way for multiple companies in their enterprise system. A provider of the service can be a third party that can access and update the algorithms remotely and maintain the same application across different companies that are using the service. At step 422, the decision making skill service software application can be implemented to add the signal level for each signal if there is only one source for the signal(s) and designate the sum as the decision making score of the individual in the user's application. As mentioned, the application maintains reference score data that is used in the display to establish context for the viewer. The reference score data such as a score before training is implemented and used across the decision making skill service software application for employees to provide objective consistency. As mentioned, the reference score data can be maintained and updated across multiple companies that use the decision making skill service software application in their enterprise system.

Relatedly, at step 410, when a new company is added as a customer of the decision making skill service software application, the data algorithms can be adapted for particular enterprise applications of that customer. The company may use a different feedback application or different email server, or there may be other variations. The application can install adapters that are specific to the customer's enterprise network and resources. This is at least because the data structure(s) and data schema may be different in each variation.

At step 424, the decision making skill service software application is preferably configured to provide a private online workspace such as via the mobile telephone or computer browser. As it would be understood, the generation of the visual graphics and networking can involve other software that is running in coordination with the decision making skill service software application. The provided workspace is preferably configured to be a private workspace that allows for self-guided interaction with the information and online tools. The private workspace provides exclusive access to the signals, decision making skill score, and related data to the designated use of that workspace. In some embodiments, the access to the data is not exclusive to the user such as when a mentor or coach is authorized by the user of that workspace. At step 428, a training application is made available to users such as by having a portal in the online workspace of individual users. The training application can be integrated into the decision making skill service software application, be a separate application on the company's enterprise network, or can be a remote service such as a third party service that offers training through an Internet connection to company employees. The users' detected signals, signals levels, decision making score, and/or potentially related data are used to identify training content that a particular user is to view or complete to increase that user's score. In simple terms, a table with threshold levels can be configured that identifies one or more corresponding training content when a signal level is below the threshold. For example, if the user has a signal level of 1.0 (a low score) for awareness gap and the threshold is 2.0, the training content for improving the awareness gap is identified from a corresponding table. The content can be displayed as options that the user can select in the application to perform the training. More complex tables or algorithms are contemplated for example by evaluating multiple signals or relationships between signals of a user, and using that to identify corresponding training content. The training application can be configured to track the completion of identified training for that user, such as by using a software that monitors the progress of a video streamed to the user. Other mechanisms can be used as well. The training application or decision making skill service software application can be configured to allow the user to interactively self report the completion of a particular training content. The completion of all or some of the identified training is recorded by the training or decision making service software application. The identified training may be designated as being mandatory for the employee. If more than one item of content materials is recommended per signal or in general, the training application or decision making skill service software application tracks whether all of the content materials have been completed.

A trigger such as a software flag is activated and stored when all of the identified training content (such as for a signal) is completed by the user. The trigger is checked to determine whether the decision making skill service software application is to collect and adapt data from the other enterprise applications. The decision making skill service software application may also determine to include additional criteria and can manage when the collection and adaptation process should proceed (e.g., per enterprise application or in general). One criteria can be that the time since the signals and score for that user is determined. This can be used to determine whether a sufficient window has past to conduct the process. Another criteria can be that the other enterprise applications can be configured to send a message to the decision making skill service software application notifying about the enterprise application now having new data for a user. For example, the employee evaluation feedback application can be configured to send a message to the decision making skill service software application that a new evaluation has been completed for that user. These criteria are used (such as the flag, time window, etc.) as a trigger by the decision making skill service software application to retrieve or collect the new data and perform the process of signal detection and new score determination using the new data (data collected since the last score and the training was completed). This automated system is configured to perform an operational loop when triggered by the decision making skill service software application. The iterative inquiry of data, collection, and detection provide an interactive process in which individual users that can see the progress from the training using the determined new signals and/or score, which can be displayed in a bar graph or other graphic for the user. This allows the user to gain, for example, private feedback on the work in the user's private workspace based on the user's internal behavior at the company since performing one or more of the identified trainings. This can be a continuous process for each user or group of users where the application is monitoring and feeding new updates so that the user's progress in the training content and score can be tracked closely over time and displayed to that user (or others if desired using the decision making skill service software application).

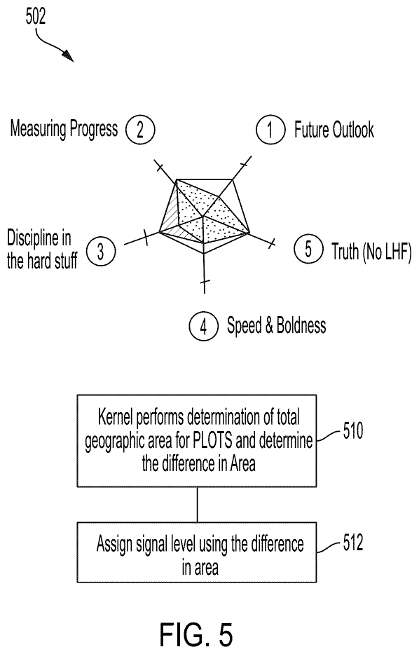

With reference now to FIG. 5, a kernel adapted for an evaluation application is illustratively described. The evaluation application can be configured through various processes to determine a score for specific characteristics as shown five characteristics (measuring progress, future outlook, truth, speed & boldness, and discipline in the hard stuff). The evaluation application is configured to include or determine a self-evaluation score for the user and a total evaluation score by that user's peers, supervisor(s), or other(s). The adapter for the evaluation application can include a kernel that detects self-awareness. The kernel can include an algorithm that plots the scores on a chart such as the shown radar chart and performs a geometric area calculation that detects the difference in area between the user's self evaluation and, for example, the user's peer evaluations (e.g., average of their evaluations for that user). The kernel can determine that there is a difference in area between the two plots and determine whether the difference is above a predetermined threshold. The kernel is configured to detect that the user has a low self-awareness score when the difference is above a threshold and produces a corresponding value in relation to the scale of the difference in the area. A wide difference indicates that the user has a significant awareness gap and would receive a very low signal level of that signal. Other geometric algorithms are contemplated to be applied to the data such as to a plot using the data to detect signals and determine signal levels. Other types of algorithms can also be included depending on the signal and the underlying data. For example, an algorithm can use two of the characteristics in the evaluation application such as truth and future outlook and if those values meet certain criteria together (e.g., one is above a number and the other is below a number), the algorithm is configured to detect that one of the signal is found using that data and a corresponding signal level is applied to the signal. As it would be understood, these would be performed automatically across the company by the enterprise system.

An illustrative process is shown in FIG. 5 for the kernel that determines awareness gap from the evaluation application. Diagram 502 display an example of a graphical display generated by the evaluation application. The graphical display shows five employee evaluation attributes arranged in radar fashion to allow for the data to be plotted. The illustrative arrangement is in the shape of a pentagon with each corner corresponding to one of the attributes. The decision making skill development service software application retrieves the evaluation data, the attributes scores for a particular user and from the user's peers (and or supervisor) of that user. The scores by user's peers may be combined by averaging them. The retrieved data is stored in the decision making skill service software application (in one or more databases) using the data structure(s) and/or schema of that application. The data can be further converted. At step 510, the kernel is exercised that performs a determination of the geometric area of the plot of the user's evaluation scores on the diagram and the geometric area of the plot of the user's peers (and/or supervisor) on the diagram. The kernel is configured to determine the difference in area between the two. At step 512, the kernel is configured to assign a signal level to the awareness signal form that user as a function of the determined difference. For example, depending on the level of difference there could be no difference or a significant difference, the former demonstrating no awareness gap and the latter demonstrating a significant weakness in the awareness gap. Other kernels for the evaluation application or other applications can use pattern recognition or geometric calculations to determine a signal and/or level to be assigned to a signal. There can be many different algorithms and each algorithm can have conditional relationships.

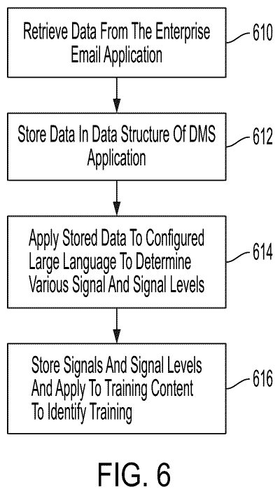

With reference now to FIG. 6, a kernel for the email application of the enterprise is illustratively shown. For example, at steps 610 and 612, the decision making skill service software application can retrieve data from the enterprise email application for one or more users. The data can cover or include emails communication to or from that user over a defined time period. The retrieved data is stored in a data structure of the decision making skill service software application so that it can be used by that resident application. At step 614, the decision making skill service software application is configured to apply the stored data to a configured large language data model that responds by determining one or more signal level or signal level. For example, the kernel (the output of the configured large language data model) determines in one instantiation a reactive balance signal level for that user. Other signals can also be detected by overlaying the kernel(s) to the email message to derive personal signals from the data indirectly. At step 616, the decision making skill service software application can store the determined signals and signal levels and apply the determined signal levels to training content (such as related tables) to identify and select training for the user to complete. In some embodiments, the kernel can be applied to the email application's database (directly) as opposed to first retrieving data. This may be more efficient depending on the amount of data involved.

A large language model (LLM) is a type of machine learning model. A large language model is a type of machine learning model that uses deep learning to understand how words, characters, and sentences work together. LLMs are trained on large amounts of data, often from the Internet, to learn patterns and relationships between words and phrases. LLMs can perform a variety of natural language processing tasks. A machine learning model refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems perform various types of statistical analyses, machine learning systems are distinguished from statistical analyses by virtue of the ability to learn without explicit programming and being rooted in computer technology. Training of a machine learning model may include building and/or updating a machine learning model from a sample dataset (referred to as a “training set”), evaluating the model against one or more additional sample datasets (referred to as a “validation set” and/or a “test set”) to decide whether to keep the model and to benchmark how good the model is, and using the model in a production environment to make predictions or decisions, or to generate content, based on new input data.

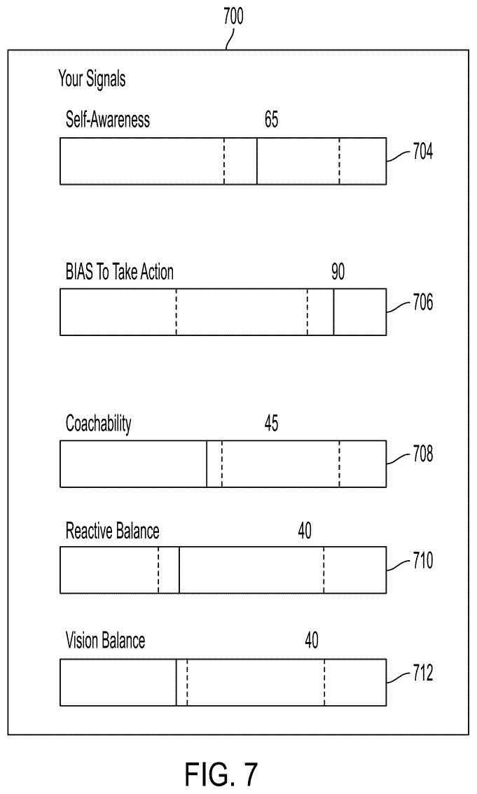

With reference now to FIG. 7, an illustrative interactive display screen 700 is shown that is displayed by and/or using the decision making skill service software application such as on a user' mobile telephone or personal computer. The display screen 700 is one example for displaying to a user (e.g., after the user logs into his or her private workspace), a graphical illustration displaying the users signals as detected and determined by adapting data from other enterprise applications to determine the user's signal levels and decision making skill numerical value. Display screen 700 shows the five signals in bar graph and numerical forms. The bar graphs 704, 706, 708, 710, and 712 each correspond to one of the signals: self-awareness, bias to take action, coachability, reactive balance, and vision balance. The dashed lines in each bar are (application-wide) reference markers that indicate a typical score versus a good versus an excellent score. The solid vertical lines demonstrate the score for that particular user for that signal. The display screen can be configured to allow the user to select one of the bar graph to in response, display options for training that provides an improvement in that signal.

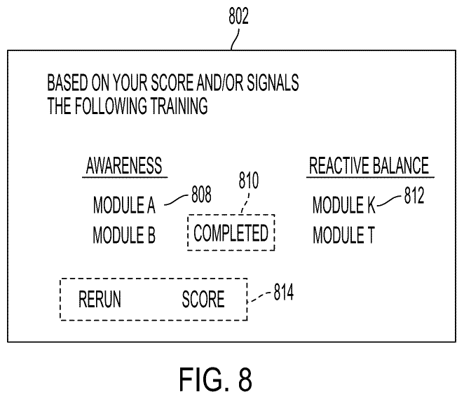

Now with reference to FIG. 8, an illustrative interactive display screen 802 is shown. Display screen 802 may be displayed by the decision making skill service software application or training application. Display screen 802 can be displayed in the user's private workspace to identify training to be completed by that user to improve the user's decision making skill (perform personal self-navigated development). For example, as shown, display screen 802 displays under the signal label of self-awareness, two modules (module A and module B) 808 that the user can select to access and perform the training provided for those modules (online) through the enterprise network and applications. Display screen 802 displays under signal label reactive balance two other modules (module K and module Z) 812 that are identified for the user to use (and select) to access and perform the corresponding training provided by those individual modules to develop the user's decision making skill. A completed label 810 can be displayed next to a module when the application has determined (e.g., through tracking) that the user has previously completed that module. Rerun score option 814 can be displayed that permits the use to direct the decision making skill service software application to exercise the overall process again such as to apply the process when there is new data that is collected by the other enterprise application (as flagged for or notified to the decision making skill service software application. In response, the described collection, conversion, and combination is performed for new data or combination of new and old data. For example, the new can be determined by the application using the a date range since the last decision signal score or signal was determine.

The decision making skill service software application and its servers are configured as a service within the enterprise internal data network or domain (e.g., the servers are enterprise servers of a company). In some embodiments, the decision making skill service software application is configured to be installed and operate on the mobile application, for example, as an application that is installed using the mobile phone provider's application store. In some implementations, a company may have employees download the application and the application is supported by a vendor using for example a cloud service that provides the described functionality as a service to the company (e.g., as opposed to installing the software on the company's enterprise servers).

The mobile or personal computer software application is configured in an arrangement in which the software application is configured primarily as an interface for viewing and interacting with a software application implemented on the enterprise servers. Preferably, processing or analysis capabilities are configured primarily or substantially only on the servers on which the application is implemented and the mobile or personal computer software application operates as an interactive viewer and data entry software client (which permits interaction with the servers and the underlying volume of data).

The schema is configured and has relationally linked data elements that are used by the decision making skill service software application to quickly assemble different messages, packets, displays screen, or responses based on a particular situation. For example, a received request can be converted to a particular query to the service application for an individual employee's received evaluation and the data can be retrieved from the retrieval system and second database and converted to date used by the decision making skill service software application.

The decision making skill service software application (and one or many of the enterprise applications) can be implemented using a cloud application service provider. For example, a cloud provider such as Amazon can be used and the related application, databases, and system can be implemented on Amazon's cloud (e.g., in simple terms, a data center housing servers by the cloud provider that runs applications for cloud provider's customers, e.g., a company that wants to have the decision making skill system for their company running in the cloud, and the installation and running of the software is provided as a service to those customers). Cloud-based software applications, servers, or other computer systems allow the electronic device to communicate with the applications, servers, or systems without depending on an enterprise network or intra-network. The applications can use a local network and/or telecommunication network (e.g., GSM, CDMA, 4G, 5G, etc.) for communications and interconnection. Optionally, virtual container systems for providing bundled software, libraries, and configuration files for executing embodiments of the systems and methods of this invention in a manner that is isolated from other virtual machine instances/applications/data/containers for preserving security and integrity of information contained therein may be provided for certain enterprises. For example, with reference to FIG. 1, the application environment can be configured to be an operating service on a cloud services provider and supporting infrastructure such as AWS by Amazon and in some instances, as an added measure of security, an individual application environment (sometimes referred to as a docker or virtual machine) is implemented for a corresponding client of the services (the evaluation service being provided to and managed from multiple clients/companies). Otherwise, the application environment is configured to serve multiple companies/enterprise clients. In the situation where there is a specific instance for an enterprise, the application and data is separated by way of cloud infrastructure to be only running and supporting that company. The instance would not support other clients. The service provider of the decision making skill service software application would have the system configured to update the algorithms and corresponding information for the customers via the cloud as new patterns or classifications developed.

The system is configured to work on the individual's personal smartphone or computer and allows them to log in to the decision making skill service software application from their smartphone or personal computer based on the system verifying and authenticating them to be an employee at the enterprise. This then provides a security token authorizing the user to use the evaluation software application on their smartphone. The communications for logging in and subsequent application use are configured to use the existing end device and available network capabilities, such as communicating over a public network such as the Internet (e.g., as opposed to limiting communications within the private network of the enterprise). The ability to create a trusted environment for the user is one of the features provided by embodiments of the present invention. Through this feature, the user knows that his communications are secure and individuals on the system or who have access to the system are not random people from the public.

Anonymity means that a contributor's identity is shielded from a user that is the subject of the contribution (the person that the contributor's contribution is related or directed to). The subject is not able to identify the contributor from the decision making skill service software application. The subject user is also unable to trace the process to identify the contributor. It should be understood that a user will personally know his current supervisor or individual peers (if pertinent) from real life experiences.

Real time means that the electronic device, server, or other computer system performs an operation at a speed that appears to be instantaneous or near instantaneous (from a human perceived sense of time) in relation to when the device receives the inputs for the operation (e.g., the composed evaluation message, the selected numerical evaluation rating, etc.). The device, server, or computer system operates such that the user of the device, server, or computer system (e.g., the author or recipient of the evaluation message) perceives the output (e.g., the published and displayed evaluation message and average numerical evaluation rating) to be produced instantaneously (e.g., without appreciable delay perceived by the user) when the device receives an input or generates data, or is selected to send the received input or generated data. This also applies to sending a request from the electronic device, server, or other computer system to receiving results in the electronic device, server, or other computer system in response to the request. The user of the device, server, or computer system perceives the results to be produced instantaneously when the user sends a request from the device, server, or computer system.

The illustrative systems and methods described herein include the embodiments that provide a trusted anonymous system. This can be important to accomplish because it provides a secure way to allow users to “enter” the decision making skill development environment for a particular company, organization, or group while at the same time maintaining anonymity within the system. The combination for example can provide anonymity while also maintaining a trusted environment. This gives the users comfort that the other users are their coworkers and not the general public that can view the decision making skill data or can comment (or troll) the system participants. This could involve checking a current employee directory before providing access to the corresponding software application.

Database schema is the logical view of the (entire) database. Data structures are the specific formats that are used to store data (File, array, trees, etc). Another way to think of it is that a database schema will contain various data structures.

A quantitative score can have particular value in that it provides an easily identifiable metric (as opposed a score that is a phrase such “excellent” that the user can quickly comprehend and integrate into their development process.

It should be understood that preferably the overall system, that integrates one or more various enterprise applications, is configured to determine signals and quantitative values for the decision making skill automatically without the need or involvement of user intervention or manipulation. To elaborate, the process that collects and adapts data from other applications to determine a quantitative value (or update the value) is automated. The system automatically interacts with other application(s) to generate the score using their data.

There is particular value in integrating enterprise applications on a cloud service (such as the ability to quickly add the service to new companies having their own networks) but other embodiments such as without using cloud service for some or all operations are contemplated.

If desired, the decision making skill development service software application is configured to integrate future updates such as to add one or more signals (signal categories) or to change or add kernels.

An electronic device may be a desktop computer, laptop computer, a tablet computer, a cellular device, a mobile device, a smartphone, a personal digital assistant (PDA), or other similar computer system having a microprocessor and memory.

The microprocessor may include an application specific integrated circuit (ASIC), programmable logic array (PLA), digital signal processor (DSP), field programmable gate array (FPGA), or any other integrated circuit. The microprocessor may also include one or more of any other applicable processors, such as a system-on-a-chip that combines one or more of a CPU, an application processor, or a reduced instruction set computing (RISC) processor.

Memory may include volatile memory, non-volatile (non-transient) memory, or both. Volatile memory may include cache memory, semi-permanent memory such as RAM, and/or one or more types of memory used for temporarily storing computer data and instructions. Non-volatile memory may include read-only memory (ROM) or other static storage device for storing static information and instructions for the microprocessor. Software applications described in this application (e.g., evaluation software application, evaluation processing software, etc.) are implemented as computer instructions that can be stored in memory, and that are executable by or that can configure the microprocessor to perform the functions or steps described herein.

The electronic device also includes a storage device. The storage device may include a hard disk drive and/or a removable storage drive, representing a floppy disk drive, a magnetic tape drive, an optical disk drive, etc.

A network may be a communications network using any suitable communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The network may also be established by using wires such as an optical fiber or Ethernet cable. A network connection interface may be a hardware device configured to support the above communications protocol such as integrated services digital network (ISDN) card, local area network (LAN) card, Ethernet card, cable modem, satellite modem, or a modem to provide a data communication connection to a corresponding type of telephone line

Server refers to a computer system or communication-oriented computer that includes the aforementioned computer components and that usually includes a faster processor, larger memory, larger storage capacity, and general capability of sustaining concurrent data communication with multiple end users, client devices, or the electronic device.

Computer system may refer to either the electronic device, the server, or other computers in this application that include a microprocessor and memory.

Although some disclosure only refers to software applications, it is understood that they also apply to the underlying computer system on which the software application is implemented.

Counterpart method and computer-readable medium embodiments would be understood from the above and the overall disclosure. Also, broader, narrower, or different combinations of the described features are contemplated, such that, for example features can be removed or added in a broadening or narrowing way.

It is understood from the above description that the functionality and features of the systems, devices, or methods of embodiments of the present invention include generating and sending signals to accomplish the actions.

It should be understood that variations, clarifications, or modifications are contemplated. Applications of the technology to other fields are also contemplated.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

The description primarily discusses a system or apparatus and counterpart method and non-transitory computer-readable medium embodiments would be understood from the above and the overall disclosure. Computer-readable medium may be permanent or semi-permanent memory such as hard drive, floppy drive, optical disk, flash memory, ROM, EPROM, EEPROM, etc., as would be known to those of ordinary skill in the art. Computer-readable medium stores computer instructions executable by a microprocessor, and execution of the instructions causes the microprocessor to perform the steps or functions described in this disclosure. Also, broader, narrower, or different combinations of the described features are contemplated, such that, for example, features can be removed or added in a broader or narrower way.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that, for example, may involve multiple possibilities, but to a person of ordinary skill in the art, a reasonable or primary understanding or meaning is understood.

Software can be implemented as distinct modules or software applications or can be integrated together into an overall application such as one that includes the user interface and that handles other features for providing the functionality to the user.

The verbs “may” and “can” are used similar to “is” to disclose embodiments in accordance with the present invention.

It is intended that the specification and examples be considered as exemplary only, with a true scope being indicated by the claims and their equivalents.

1. A computer-implemented system for decision-making skill development of employees of a company, comprising:
a computer configured using non-transient memory to execute computer readable instructions, the instructions when executed performing steps comprising:
implement one or more enterprise applications on the enterprise network of the company, each enterprise application adapted to provide a different service to the employees that login to use the corresponding service over the enterprise network, and each of the plurality of enterprise applications configured to have different corresponding database schema and data structures that are resident in that application for operating that application and each of the plurality of the enterprise applications is configured to have a corresponding database that implements the corresponding database schema and data structures;
implement a decision making skill development service software application as an enterprise application on the enterprise network with the one or more enterprise applications, wherein the decision making skill development service software application is configured to determine a quantitative value for the decision making skill of individual employees and determine one more signals or signal levels that are components of the decision making skill of individual employees, the determinations being made from data adapted from the one or more other enterprise applications, wherein the corresponding database schema and data structures of the decision making skill development service is different from the database schema and data structures of the one or more other enterprise applications;
implement one or more adapters, each adapter configured to operate with a corresponding specific one of the one or more other enterprise applications and configured to collect resident data about individual employees from the corresponding specific one of the one or more other enterprise applications, wherein each adapter comprises a set of kernels and each set is adapted for a corresponding one of the one or more other enterprise applications and wherein each kernel comprises an algorithm that detects one of the defined signals and/or its signal level from the collected resident data of the corresponding specific one of the other enterprise applications, the kernel applying the algorithm to produce a particular signal and/or signal level as a function of the collected resident data, and wherein one or more signals or signal levels are stored by the decision making skill development service software application in accordance with the database schema and data structures defined for the decision making skill development service software application;
identify the quantitative value for the decision making skill for an individual employee by combining the produced signals and/or signal levels which were produced from data about the particular employee from other enterprise applications;
store the quantitative value for later retrieval;
display an interactive display screen that displays the quantitative value to the particular employee;
implement a training application that comprises a set of online training courses;
implement an algorithm that uses the signal and/or signal levels for the quantitative value of the decision making skill to identify a corresponding subset of the one or more of the training courses; and
provide an interface configured to allow the particular employee to selectively access and use the corresponding subset of the one or more of the training courses.

2. The computer implemented system of claim 1 wherein the computer is further configured using the computer readable instructions to implement a private workspace for the particular employee, wherein the private workspace is for exclusive use of the particular employee to view the quantitative value and access the corresponding subset of the one or more of the training courses;

3. The computer-implemented system of claim 1 wherein the decision making skill development service software application is configured to process collected resident data to anonymize contributor information.

4. The computer implemented system of claim 1 wherein a table is implemented that identifies the corresponding subset of the one or more training courses using the one or more signal levels of the particular employee.

5. The computer implemented system of claim 1 wherein the system stores the quantitative value as a reference and is configured to collect data and run one or more kernels again in response to determining a flag has been triggered.

6. The computer implemented system of claim 1 wherein the decision making skill development service software application is configured to display a bar graph containing the quantitative value and reference markers for levels of achievement.

7. The computer implemented system of claim 1 wherein one of the other enterprise application is an employee evaluation application and the adapters for the employee evaluation application adapts resident data of the employee evaluation application to determine one or more signals and/or signal levels of the particular employee.

8. The computer implemented system of claim 1 wherein one of the other enterprise application is an anonymous employee feedback application and the adapters for the anonymous employee feedback application adapts resident data of the anonymous employee application to determine one or more signals and/or signal levels of the particular employee.

9. The computer implemented system of claim 1 wherein the algorithm of one or more kernels comprises performing a geometric calculation on the collected resident data to determine one or more signals or signal levels.

10. The computer implemented system of claim 1 wherein the enterprise application are implemented as cloud service that makes the services available to the employees through the Internet.

11. A computer-implemented system of developing the decision making skill of individual employees, comprising:
a computer configured using non-transient memory to execute computer readable instructions, the instructions performing steps comprising:
storing information in a different database schema and corresponding data structures in each of a plurality of enterprise applications accessible to a corresponding company's employees, wherein each application stores information about individual employee in connection with a different service implemented by that enterprise application;
provide access to the plurality of enterprise applications to the company's employees through login access to an enterprise network to generate and store data in accordance with the database schema and corresponding data structures of the corresponding enterprise application;
implement a decision making skill development service software application comprising a plurality of adapters configured to collect and convert the stored data in the other enterprise applications to detected signals carried in the stored data and storing the detected signals in accordance with the database schema and data structure of the decision making skill development service software application;
automatically trigging the decision making skill development service software application flag when data about the individual employee in an enterprise application meets a predefined criteria;
in response to the flag, operating one or more adapters to collect and convert updated stored data in the one or more enterprise applications to detect an updated signal; and
tracking changes in the signals in response to updates to the data in the enterprise applications for display and user-interaction.

12. The computer implemented system of claim 1 wherein the system is configured to automatically control when the updated signal is determined using the flag.

13. The computer implemented system of claim 1 wherein the system is configured to implement a set of kernels for each adapter, wherein each kernel is adapted to detect a signal carried by the data of a corresponding enterprise application.

14. The computer implemented system of claim 1 wherein the decision making skill software application is configured to receive a notification that data about the particular employee is updated and a separate notification that the particular employee has completed using designated online content.

15. The computer implemented system of claim 1 wherein the decision making skill software application is configured to determine a quantitative score for the decision making skill of a particular employee using one or more signals.

16. The computer implemented system of claim 1 wherein the decision making skill software application is configured to display training options based on the signals.
